(19) United States
(12) Patent Application Publication
(10) Pub. No.: US 2009/0140495 A1
(43) Pub. Date: Jun. 4, 2009

(54) Shaft Seal

(75) Inventors: Thomas Dreifert, Kerpen (DE); Wolfgang Giebmanns, Ertstadt (DE); Bernhard Kliem, Munster (DE); Heinz Thoren, Neuss (DE)

Correspondence Address: Fay Sharpe LLP, 1228 Euclid Avenue, 5th Floor, The Halle Building, Cleveland, OH, 44115, US

(73) Assignee: OBERLIKON LEYBOLD VACUUM GMBH, Koln (DE)

(21) Appl. No.: 11/887,601

(22) PCT Filed: Mar. 30, 2006
(86) PCT No.: PCT/EP2006/061185

§ 371 Date: Oct. 1, 2007

(30) Foreign Application Priority Data
Apr. 2, 2005 (DE) 10 2005 015 212.0

(51) Int. Cl. F16J 15/447

(52) U.S. Cl. 277/431

(57) ABSTRACT

A shaft seal which is in particular suitable for vacuum pumps, such as screw pumps, comprises an inner sealing ring (18) connectable with the shaft, and an outer sealing ring (20) surrounding said inner sealing ring (18). In the outer sealing ring (20) a circumferential groove (30) is provided into which seal gas is adapted to be fed via a feed channel (22). Further, a seal gas disk (34) is connectable with the shaft (10), the seal gas disk (34) comprising a projection (32) extending towards said groove (30). Thereby a seal gas chamber (28) is defined in the groove (30). The seal gas chamber (28) is connected with a sealing gap (40) provided between the inner and the outer sealing ring (18,20) via a chamber gap (36), through which the seal gas is adapted to flow. Adjacent to the sealing gap (40) a separating chamber (42) defined by the inner and the outer sealing ring (18,20) is arranged, the separating chamber (42) being connected with a discharge channel (44) for the purpose of discharging the seal gas.

The invention relates to a shaft seal which is in particular suitable for vacuum pumps, such as screw pumps.

A shaft seal for screw pumps is described in DE 102 07 929, for example. A screw pump usually comprises two rotor shafts which are connected with the rotor in a respective rotor section. Further, the shaft is connected with a bearing which is usually lubricated with oil. Between the bearing and the rotor section a shaft seal is provided. In particular when a vacuum is generated, the seals must meet high demands since oil or other lubricant must be prevented from flowing from the bearing side to the rotor side. DE 102 07 929 proposes a combination of an oil seal arranged on the bearing side, and a gas seal provided on the rotor side. Here, the gas seal is configured as a labyrinth seal in combination with a plurality of piston rings. Between the gas seal and the oil seal a radially extending separation chamber is defined which is connected with the surroundings via a separation chamber ventilation channel. The ventilation channel allows the separation chamber to be set to a desired gas pressure, preferably to ambient pressure. Thus, the pressure difference dropping across the gas seal, and the pressure difference dropping across the oil seal can be adjusted. A corresponding pressure adjustment prevents oil from flowing from the bearing side through the oil seal and through the gas seal to the suction chamber of the screw pump.

In such a shaft seal corrosive media, in particular moisture, may get in contact with the piston rings and provoke damage to or even failure of the shaft seal. Further, poisonous or explosive gases may escape from the separating chamber.

Further, it is common practice to feed a seal gas to the shaft seal. Here, the seal gas is fed to the shaft seal such that the lubricant, in particular the oil, is prevented from entering into the dry region and/or the suction chamber of the screw pump. This is realized by feeding the seal gas between two piston ring groups or two labyrinth seals. Feeding of seal gas results in a pressure increase in the gear chamber where the lubricant for lubricating the bearings is located. When the gear chamber is ventilated, oil mist thus escapes from the gear chamber. Consequently, oil escapes into the surroundings.

It is an object of the invention to provide a shaft seal whose components are protected against damage by corrosive media, dirt and the like.

According to the invention, this object is achieved through the features of claim 1.

The shaft seal according to the invention, which is in particular suitable for vacuum pumps and preferably for screw pumps, comprises an inner sealing ring which is in particular connectable with a rotor shaft. The inner sealing ring is at least partly surrounded by an outer sealing ring, wherein the outer sealing ring preferably is a stationary ring retained in a housing, for example. According to the invention, a seal gas chamber is provided which is at least partly defined by the sealing rings, and which is supplied with seal gas via a feed channel preferably arranged in the stationary outer sealing ring. The seal gas chamber is connected with a sealing gap defined between the inner and the outer sealing ring, and with an exit gap such that seal gas can escape from the seal gas chamber and enter both into the sealing gap and into the exit gap. The exit gap is preferably connected with a suction chamber. The sealing gap and the exit gap are thus preferably in fluid communication with a respective side of the seal.

Escape of seal gas both through the sealing gap and through the exit gap ensures that no corrosive media or dirt particles and the like can reach sensitive portions of the seal, such as piston rings.

Preferably, the cross section of the sealing gap and the exit gap is dimensioned such that the flow resistance in the sealing gap is larger than in the exit gap. Consequently, a larger quantity of seal gas flows towards the suction chamber and/or a side facing away from the gear, and thus it is further ensured that no corrosive media and the like enter into the seal. A small portion of the seal gas flows through the sealing gap, where preferably piston rings are arranged, and into an adjacent separating chamber.

In the outer and/or the inner sealing ring preferably a circumferential groove is arranged. For defining the seal gas chamber in the groove, preferably a seal gas disk connectable with the shaft is provided. Preferably, the seal gas disk comprises a projection extending into the groove, wherein the dimensions of the particularly annual projection are selected such that in the assembled state the projection does not fully extend into the groove for defining the seal gas chamber. The seal gas fed via the feed channel preferably provided in the outer sealing ring can escape from the seal gas chamber through a chamber gap. The chamber gap is defined by the arrangement and the configuration of the sealing gas disk. Preferably, the chamber gap is provided between the groove and the projection extending into the groove. The seal gas is adapted to flow from the chamber gap into a sealing gap which is provided between the inner and the outer sealing ring. Preferably, piston rings and/or a labyrinth seal provided for sealing purposes are arranged in the region of the sealing gap. The seal gas flows through the sealing gap into a separating chamber arranged adjacent to the sealing gap, said separating chamber preferably being defined by the inner and the outer sealing ring. The separating chamber is connected with a discharge channel for discharging the seal gas, wherein the discharge channel preferably is connected with the surroundings.

Providing a sealing gap adjacent to a separating chamber comprising a discharge channel according to the invention, ensures that no corrosive media or dirt particles or the like enter into the sealing gap. Thus the piston rings preferably arranged in the sealing gap are protected against damage.

Preferably, the seal gas chamber comprises an exit gap which is connected with the chamber gap, or which is independent of the chamber gap. The exit gap is connected with the suction chamber. Thus explosive or toxic gases are prevented from escaping from the suction chamber and into the surroundings through the sealing gap and/or the gas seal, for example. This is ensured in particular by a small quantity of seal gas constantly flowing into the suction chamber through the exit gap.

Providing a separating chamber comprising a discharge channel in particular offers the advantage that the seal gas cannot enter into a gear case. Thus ventilation of a gear case, whereby oil may be entrained, is not required. Further, the seal gas flowing through the discharge channel keeps off corrosive media or particles.

For ensuring that no lubricant, in particular oil, from a gear chamber or from the lubricated bearings enters into the separating chamber, at least one centrifugal chamber is arranged preferably between the separating chamber and the gear chamber and/or the bearing. Said centrifugal chambers preferably are essentially radially configured chambers where the lubricant is centrifuged. The centrifugal chambers preferably are connected with the gear chamber for the purpose of feeding back the lubricant. In a particularly preferred aspect, the at least one centrifugal chamber is also defined by the inner and the outer sealing ring. Here, as small a gap as possible is provided between the two sealing rings.

Preferably, a throttle is arranged in the seal gas chamber connected with the feed channel, said throttle being operated in a supercritical manner. Thus it is ensured that a constant seal gas mass flow is fed to the seal gas chamber independently of the pressure prevailing in the suction chamber. Since the flow resistance of the exit gap is considerably lower than that of the sealing gap, a major portion of the seal gas flows into the suction chamber even if the pressure prevailing here exceeds the pressure in the separating chamber.

The supercritical throttle and the selected flow resistances cause the pressure in the separating chamber to adjust to the pressure in the suction chamber and to exceed the latter. For this purpose, the seal gas preferably is additionally fed via a pressure controller. Preferably, a filter is arranged upstream of the nozzle for the purpose of protecting the nozzle against fouling.

A particular advantage of the shaft seal according to the invention is that feeding of seal gas is an optional feature. Depending on the requirements to be met by the shaft seal, feeding of protective gas may be omitted. The shaft seal offers good sealing characteristics even if no protective gas is fed.

Further, the invention relates to a vacuum pump, in particular a screw pump, comprising at least one rotor shaft. The rotor shaft is connected with a rotor and a bearing. Between the rotor, which preferably is arranged in a suction chamber, and the bearing, which usually is an oil-lubricated bearing arranged in a gear case, a shaft seal is provided. According to the invention, the shaft seal is configured as described above.

Embodiments of the invention will now be described in greater detail with reference to the drawings in which:

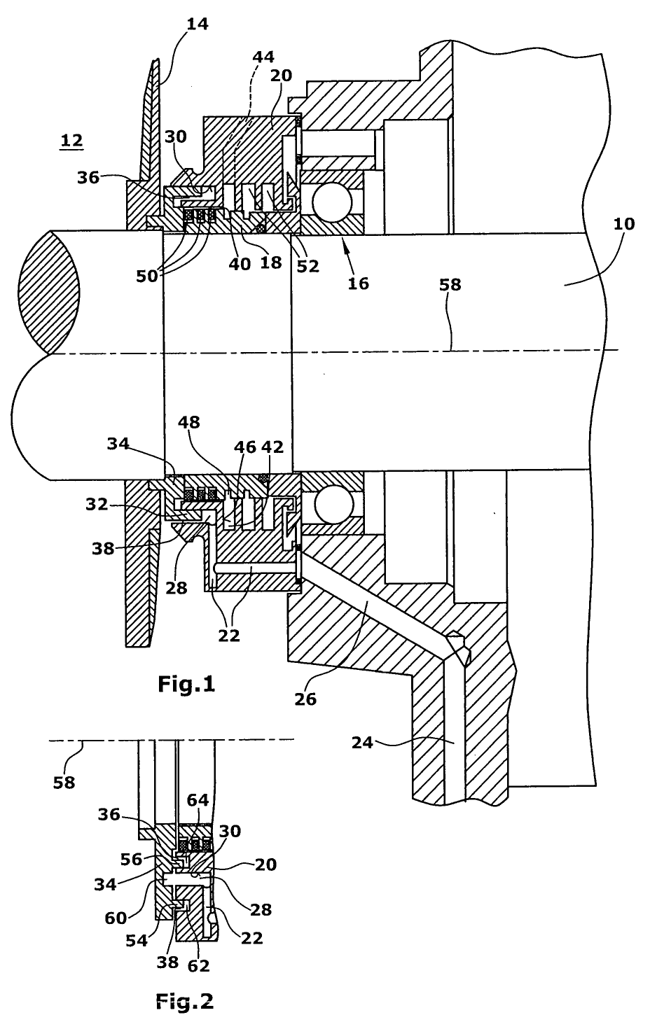

FIG. 1 shows a schematic sectional view of a first embodiment of a screw pump rotor shaft in the region of the shaft seal,

FIG. 2 shows a part-sectional view of a second embodiment of the shaft seal in the region of a seal gas chamber,

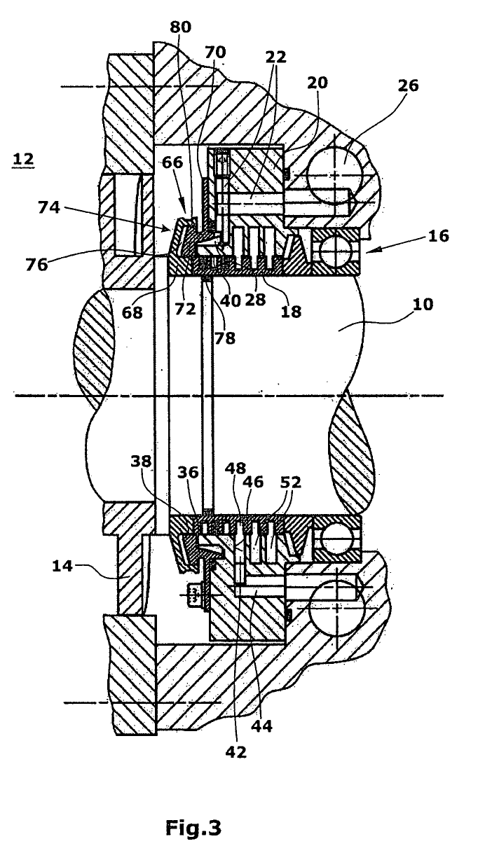

FIG. 3 shows a schematic sectional view of another embodiment of a screw pump rotor shaft in the region of the shaft seal,

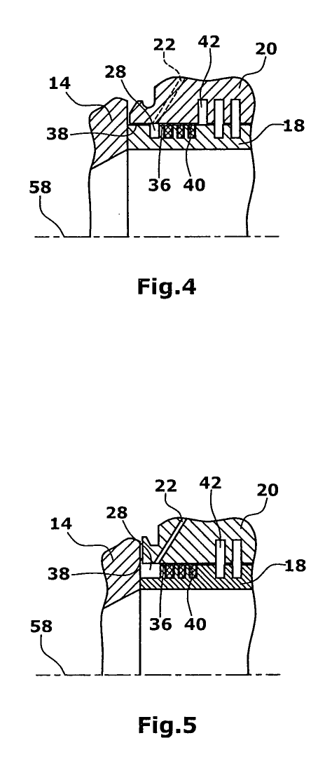

FIG. 4 shows a part-sectional view of another embodiment of the shaft seal in the region of a seal gas chamber, and

FIG. 5 shows a part-sectional view of another embodiment of the shaft seal in the region of a seal gas chamber.

A rotor shaft 10 is connected with a rotor 14 on a suction chamber side or dry side 12, wherein, for the sake of a simplified illustration, only one rotor blade of a rotor configured as a screw-type rotor, for example, is shown. Further, the rotor shaft 10 has connected therewith a bearing 16 which, in the illustrated embodiment, is a ball bearing. The bearing 16 is oil-lubricated, for example. Between the rotor 14 and the bearing 16 the shaft seal according to the invention is arranged.

In the first embodiment (FIG. 1) the shaft seal comprises an inner sealing ring 18 which is permanently connected with the rotor shaft 10. The inner sealing ring 18 is surrounded by an outer sealing ring 20 which is permanently arranged in a housing not shown, for example. In the outer sealing ring 20 a feed channel 22 is provided which is connected with a channel 26 arranged in a housing 24. Via the channel 26 and the feed channel 22 a seal gas can be fed to a seal gas chamber 28.

In the illustrated embodiment (FIG. 1), the seal gas chamber is defined by a circumferential groove 30 provided in the outer sealing ring 20, wherein a projection 32 of a seal gas disk 34 permanently connected with the shaft 10 extends into the groove 30. The outer dimensions of the circular ring-shaped projection 32 are slightly smaller than the dimensions of the groove 30 such that between the projection 32 and the groove 30 a chamber gap 36 is defined on the inside, and an exit gap 38 is defined on the outside.

Seal gas can escape from the seal gas chamber 28 through the two gaps 36, 38.

Seal gas enters into the suction chamber 12 through the exit gap 38.

The chamber gap 36 is connected with a sealing gap 40 such that seal gas flows from the seal gas chamber 28 through the chamber gap 36 and into the sealing gap 40, and flows through the latter into a separating chamber 42.

From the separating chamber 42 the seal gas flows through a discharge channel 44 into the surroundings or into a collection chamber, for example.

The separating chamber 42 is defined by a radial groove 46 provided in the outer sealing ring 20, and an inner radial groove 48 provided in the inner sealing ring 18, wherein the two grooves 46,48 are arranged opposite each other.

In the illustrated embodiment, three piston rings 50 are arranged in the sealing gap 40. The piston rings 50 are disposed in respective grooves of the inner sealing ring 18 with their opposite side resting against the outer sealing ring. The quantity of seal gas escaping through the sealing gap 40 is thus extremely small as compared with the quantity of seal gas escaping into the suction chamber 12 through the exit gap 38. Preferably, approximately 80% of the seal gas escapes through the exit gap 38.

On the shaft seal side facing the bearing 16 two centrifugal chambers 52 are provided in the outer sealing ring 20. The centrifugal chambers 52 are defined by essentially radially extending annular grooves in the outer sealing ring 20. The centrifugal chambers serve for centrifuging or receiving a lubricant, in particular lubricating oil, flowing from the bearing 16 towards the rotor 14. The centrifugal chambers 52 are connected with the gear case via a trans-verse bore not shown for the purpose of feeding back the lubricant.

Another embodiment of the seal gas chamber is shown in FIG. 2, wherein the same or similar components are identified by the same reference numerals. In this embodiment, the seal gas disk 34 does not comprise a projection extending towards the groove 30. Instead, the seal gas disk 34 comprises two rotation-symmetric projections 54,56, wherein the projection 54 is arranged at a larger distance to a centerline 58 than the projection 56. Between the two projections 54,56 the seal gas chamber 28 is arranged, wherein in the seal gas disk 34 a groove 60 located opposite the groove 30 is defined for enlarging the seal gas chamber 28.

The two projections 54,56 extend into two circular ring-shaped grooves 62 and 64, respectively, provided in the outer sealing ring 20. The outer dimensions of the annular projections 54,56 are slightly smaller than the width of the grooves 62,64. Thus the exit gap 38 is defined between the projection 54 and the groove 62, and the chamber gap 36 is defined between the groove 64 and the projection 56.

In another embodiment (FIG. 3) identical or similar components are again identified by the same reference numerals.

This embodiment (FIG. 3) essentially differs from those described above in that a seal gas disk 66, which has the same function as the seal gas disk 34, is of bipartite configuration. Here, an inner seal gas ring 68 of the seal gas is disk 66 is permanently connected with the shaft 10. An outer seal gas ring 70 may be permanently connected with the outer sealing ring 20. The outer seal gas ring 70 comprises a head-shaped projection 72 which is rotation-symmetric relative to the symmetry line 58, said projection extending into a correspondingly configured recess 74 in the inner seal gas ring, which recess is also rotation-symmetric relative to the axis 58. Thus a second seal gas chamber 76, which is also of annular configuration, is provided in the seal gas disk 66 between the two seal gas rings 68,70. This second seal gas chamber 76 supplies the seal gas, which has passed through the gap 38, to a second gap 80 via which the seal gas is uniformly distributed over the circumference, flows into the suction chamber 12 thus keeping off particles, condensates and corrosive or toxic gases. Since the seal gas is supplied into the suction chamber 12 through the annular gap 80 in the main supplying direction of the rotor 14, the opening of the annular gap 80 remains in the windshadow of the seal gas disk 66. In operation without seal gas, this considerably reduces the risk that particles or condensate from the supplied gas flow enter into the annular gap 80. This annular gap 80 has a larger annular surface than the annular gap 38 such that the gap 38 defines the determining throttle at the outlet side of the seal gas chamber 28. The seal gas chamber 28 is connected with the annular gaps 36 and 38 via a distributing groove 78, wherein the annular gap 36 is very short between the outer sealing ring 20 and the inner sealing ring 18, and supplies the gas directly to the sealing gap 40 which, in turn, is confined by the piston rings 50 such that an extremely small quantity of the seal gas passes through the sealing gap.

FIGS. 4 and 5 show part-sectional views of another two embodiments, wherein similar or corresponding components are identified by the same reference numerals.

As shown in the two Figures, no seal gas ring is provided. According to FIG. 4, the seal gas chamber 28 is defined by the two sealing rings 18,20, wherein the corresponding groove is arranged in the inner sealing ring 18.

In the embodiment shown in FIG. 5, the seal gas chamber 28 is defined by the inner sealing ring 18, the outer sealing ring 20 and the rotor 14.

1. A shaft seal, in particular for vacuum pumps, such as screw pumps, comprising
an inner sealing ring connectable with a shaft,
a stationary outer sealing ring at least partly surrounding said inner sealing ring,
a seal gas chamber at least partly defined by said sealing rings, into which seal gas chamber seal gas can be introduced via a feed channel,
a sealing gap connected with said seal gas chamber and arranged between the inner and the outer sealing ring, and
an exit gap connected with said seal gas chamber and preferably connected with a suction chamber.

2. The shaft seal according to claim 1, wherein the flow resistance in the sealing gap is larger than in the exit gap.

3. The shaft seal according to claim 1, wherein the seal gas chamber is at least partly defined by a groove provided in the outer and/or the inner sealing ring.

4. The shaft seal according to claim 1, further including:
a seal gas disk, connectable with the shaft, for defining the seal gas chamber.

5. The shaft seal according to claim 1, wherein the seal gas chamber is defined by two non-rotating components.

6. The shaft seal according to claim 1, further including:
a separating chamber adjacent to the sealing gap and defined by the inner and the outer sealing ring, said separating chamber being connected with a discharge channel for discharging the seal gas.

7. The shaft seal according to claim 5, wherein the seal gas disk comprises a projection extending into the groove for defining the seal gas chamber.

8. The shaft seal according to claim 6, wherein the separating chamber comprises an outer radial groove arranged in the outer sealing ring, and/or an inner radial groove arranged in the inner sealing ring.

9. The shaft seal according to claim 1, further including:
a sealing element including at least one piston ring, arranged in the sealing gap.

10. The shaft seal according to claim 6, wherein the discharge channel is connected with the surroundings.

11. The shaft seal according to claim 1, wherein the groove provided in the outer and/or the inner sealing element essentially extends in axial direction.

12. The shaft seal according to claim 1, further including:
at least one centrifugal chamber defined by the inner and the outer sealing ring and arranged between the separating chamber and a gear chamber.

13. The shaft seal according to claim 1, further including:
an exit gap is defined by the projection arranged in the groove, said exit gap being disposed opposite the chamber gap, and being provided for the exit of seal gas into a suction chamber.

14. The shaft seal according to claim 1, wherein the outer sealing ring and/or the seal gas disk are of bipartite configuration for defining a second seal gas chamber.

15. The shaft seal according to claim 1, wherein the feed channel is connected with a pressure controller and/or a flow controller.

16. The shaft seal according to claim 1, wherein the seal gas chamber extends to an annular gap from which the seal gas flows into the suction chamber, wherein the seal gas flow is uniformly distributed over the circumference.

17. The shaft seal according to claim 1, wherein the seal gas flows in the main supplying direction of the rotor through an annular gap, and the annular gap opens in the windshadow of a seal gas disk into the suction chamber.

18. A screw vacuum pump comprising:
a rotor shaft connected with a rotor and a bearing, wherein between said rotor and said bearing a shaft seal according to claim 1 is arranged.

19. The shaft seal according to claim 5, wherein the two non-rotating components include the outer sealing ring and an outer seal gas ring.
